(19) United States
(12) Patent Application Publication
(10) Pub. No.: US 2024/0419419 A1
(43) Pub. Date: Dec. 19, 2024

(54) PLUGIN CREATION AND DATA QUERY ASSOCIATED WITH DIGITAL ASSISTANT INTERACTION

(71) Applicants: Beijing Zitiao Network Technology Co., Ltd., Beijing (CN); Lemon Inc., Grand Cayman (KY)

(72) Inventors: Yiguo WANG, Beijing (CN); Xing SHI, Beijing (CN); Xin ZHONG, Beijing (CN); Yang LIU, Beijing (CN); Linhao HUANG, Beijing (CN); Yibing ZHU, Los Angeles, CA (US)

(21) Appl. No.: 18/815,337

(22) Filed: Aug. 26, 2024

(30) Foreign Application Priority Data
Aug. 25, 2023 (CN) 2023110883560
Oct. 31, 2023 (CN) 2023114341886

(51) Int. Cl. G06F 8/60; G06F 8/34

(52) U.S. Cl. CPC G06F 8/60; G06F 8/34

(57) ABSTRACT

According to embodiments of the present disclosure, a solution for plugin creation and data query associated with a digital assistant are provided. A method comprises: providing a creation page for creating a target plugin, wherein the creation page presents a plugin creation template corresponding to a type of the target plugin to be created, and the plugin creation template including at least one information input component; obtaining plugin creation information about the target plugin at least via at least one information input component in the plugin creation template; and releasing the target plugin based on the plugin creation information, the released target plugin being selectable for interaction between a user and a digital assistant.

### CROSS-REFERENCE TO RELATED APPLICATIONS

This application claims priority to Chinese Patent Application No. 202311088356.0 filed on Aug. 25, 2023, and entitled “METHODS, APPARATUSES, DEVICE AND STORAGE MEDIUM FOR PLUGIN CREATION” and to Chinese Patent Application No. 202311434188.6 filed on Oct. 31, 2023, and entitled “METHODS, APPARATUSES, DEVICE AND STORAGE MEDIUM FOR DATA QUERY”.

### FIELD

Example embodiments of the present disclosure generally relate to the field of computers, and in particular, to plugin creation and data query associated with digital assistant interaction.

### BACKGROUND

With the development of information technologies, various terminal devices may provide various services in work and life to people. For example, an application providing services may be deployed in the terminal device. The terminal device or application may provide a digital assistant function to the user to assist the user in using the terminal device or application. The user can complete diversified operations by means of plugins during interaction with the digital assistant. It is now a technical problem to be explored about how to quickly and quickly create a plugin meeting a user requirement.

### SUMMARY

In a first aspect of the present disclosure, a method for plugin creation is provided. The method includes: providing a creation page for creating a target plugin, wherein the creation page presents a plugin creation template corresponding to a type of the target plugin to be created, and the plugin creation template comprises at least one information input component; obtaining plugin creation information about the target plugin at least via the at least one information input component in the plugin creation template; and releasing the target plugin based on the plugin creation information, the released target plugin being selectable for interaction between a user and a digital assistant.

In a second aspect of the present disclosure, an apparatus for plugin creation is provided. The apparatus includes: a page providing module configured to provide a creation page for creating a target plugin, wherein the creation page presents a plugin creation template corresponding to a type of a target plugin to be created, the plugin creation template comprises at least one information input component; an information obtaining module configured to obtain plugin creation information about the target plugin at least via the at least one information input component in the plugin creation template; and a plugin releasing module configured to release the target plugin based on the plugin creation information, the released target plugin being selectable for interaction between a user and a digital assistant.

In a third aspect of the present disclosure, a method for data query is provided. The method includes: receiving a data query request for a target data source, the data query request indicating a first entity identifier to be queried; mapping the first entity identifier into a plurality of first indexes respectively by using a plurality of mapping functions, each mapping function mapping a plurality of different entity identifiers to a same index; based on the plurality of first indexes and index information of data entities in the target data source, filtering a plurality of sets of first data entities that respectively match the plurality of first indexes from the target data source, the index information of each set of data entities matching with one of the plurality of first indexes; and determining a query result for the data query request from an intersection set of the plurality of sets of first data entities, the query result indicating at least a part of data entities included in the intersection set.

In a fourth aspect of the present disclosure, a method for data query is provided. The method includes: receiving a data query request for a target data source, the data query request indicating a first folder identifier to be queried; in response to determining that a first folder identified by the first folder identifier has a subfolder, obtaining at least one second folder identifier of at least one subfolder in the first folder based on the first folder identifier; and filtering a plurality of data entities matching the first folder identifier and the at least one second folder identifier from the target data source based on index information of data entities in the target data source, the index information of each data entity at least comprising a folder field indicating the first folder identifier and a folder identifier of the at least one second folder identifier.

In a fifth aspect of the present disclosure, a method for data query is provided. The method includes: determining a target data source of a question answering plugin used by a digital assistant based on a first configuration operation of a user; receiving a data query request of the user in an interaction between the user and the digital assistant; and presenting a query result of the digital assistant to the user, wherein the query result is obtained by the digital assistant which matches the data query request with the target data source using the question answering plugin.

In a sixth aspect of the present disclosure, an apparatus for data query is provided. The apparatus includes a request receiving module configured to receive a data query request for a target data source, the data query request indicating a first entity identifier to be queried; an index mapping module configured to map the first entity identifier into a plurality of first indexes respectively by using a plurality of mapping functions, each mapping function mapping a plurality of different entity identifiers to a same index; a data filtering module configured to filter a plurality of sets of first data entities that respectively match the plurality of first indexes from the target data source based on the plurality of first indexes and index information of data entities in the target data source, the index information of each set of data entities matching one of the plurality of first indexes; and a result determination module configured to determine a query result for the data query request from an intersection set of the plurality of sets of first data entities, the query result indicating at least a part of data entities included in the intersection set.

In a seventh aspect of the present disclosure, an apparatus for data query is provided. The apparatus includes: a request receiving module configured to receive a data query request for a target data source, the data query request indicating a first folder identifier to be queried; an identifier obtaining module configured to, in response to determining that a first folder identified by the first folder identifier has a subfolder, obtain at least one second folder identifier of at least one subfolder in the first folder based on the first folder identifier; and a data filtering module configured to filter, from the target data source, a plurality of data entities matching the first folder identifier and the at least one second folder identifier based on index information of data entities in the target data source, index information of each data entity at least comprising a folder field indicating the first folder identifier and a folder identifier of the at least one second folder identifier.

In an eighth aspect of the present disclosure, an apparatus for data query is provided. The apparatus includes a data source determination module configured to determine a target data source of a question answering plugin used by a digital assistant based on a first configuration operation of the user; a request receiving module configured to receive a data query request of the user in an interaction between the user and the digital assistant; and a result presenting module configured to present a query result of the digital assistant to the user, wherein the query result is obtained by the digital assistant which matches the data query request with the target data source using the question answering plugin.

In a ninth aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform any of the method of the first aspect and/or the methods of the third aspects to the fifth aspect.

In a tenth aspect of the present disclosure, a computer-readable storage medium is provided. The computer-readable storage medium stores a computer program, and the computer program is executable by the processor to implement any of the method of the first aspect and/or the methods of the third aspects to the fifth aspect.

It should be understood that the content described in this section is not intended to limit the key features or essential features of the embodiments of the present disclosure, nor is it intended to limit the scope of the present disclosure. Other features of the present disclosure will become readily understood from the following description.

### BRIEF DESCRIPTION OF DRA WINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

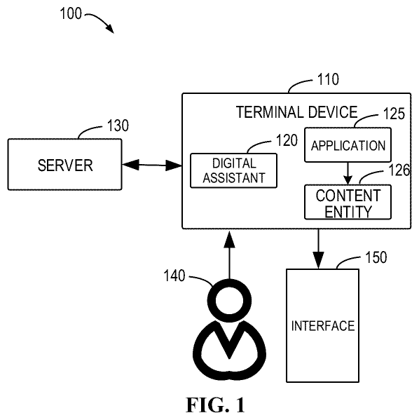

FIG. 1 illustrates a schematic diagram of an example environment in which embodiments of the present disclosure can be implemented;

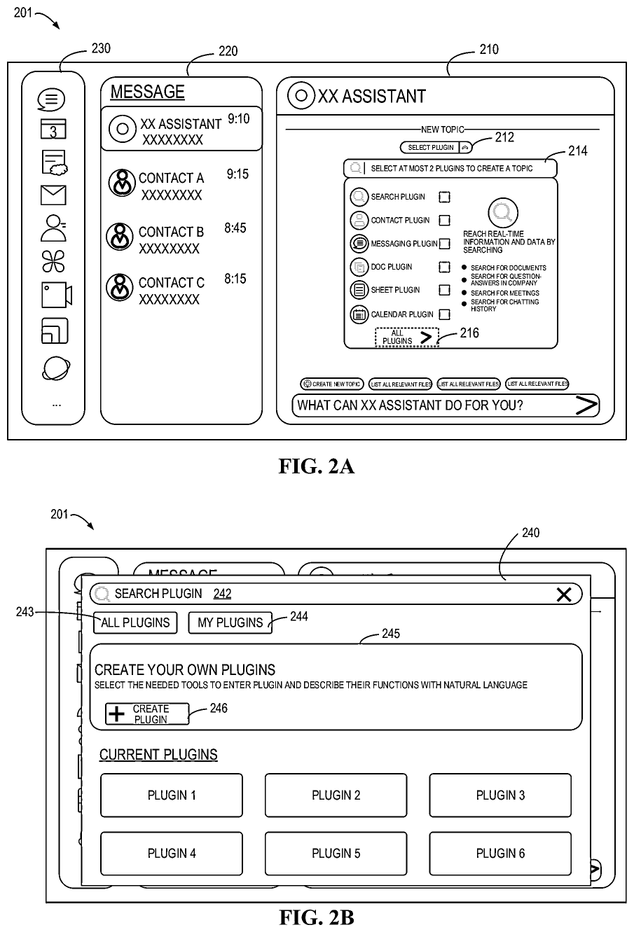

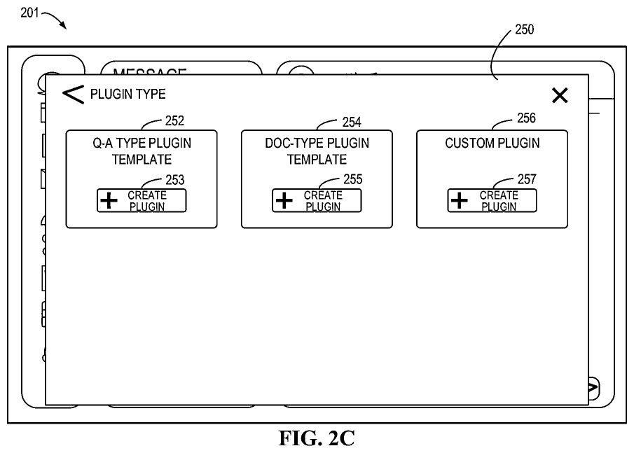

FIG. 2A to FIG. 2C are schematic diagrams of an example interface for initiating a plugin creation request according to some embodiments of the present disclosure;

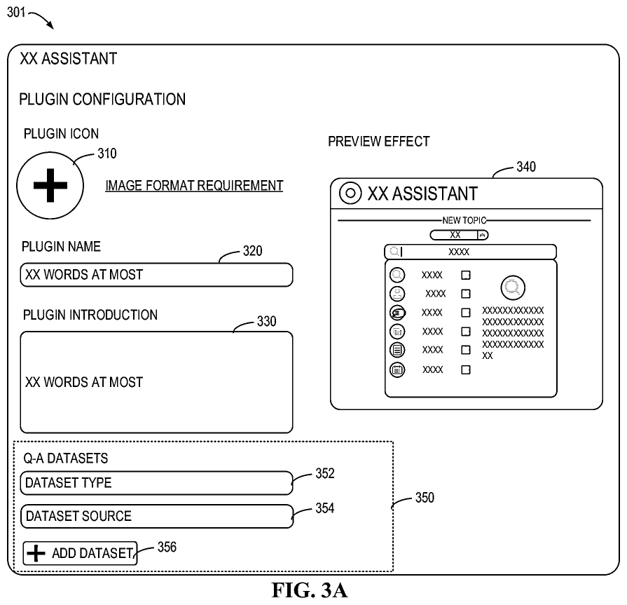

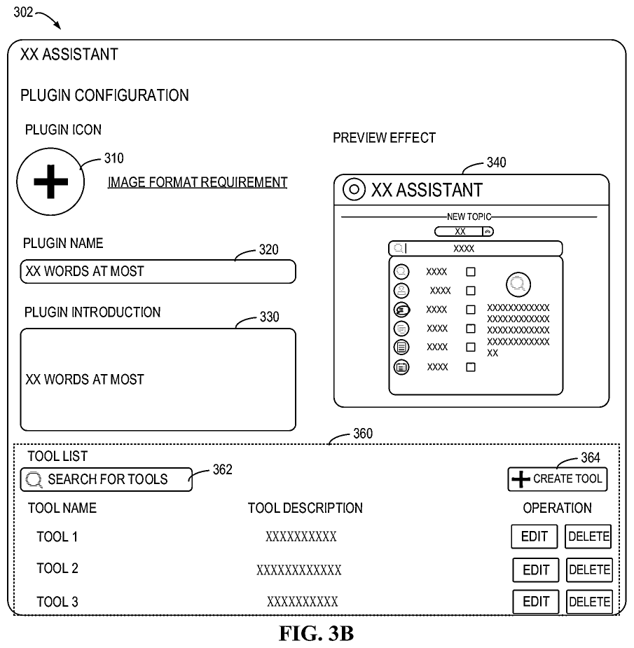

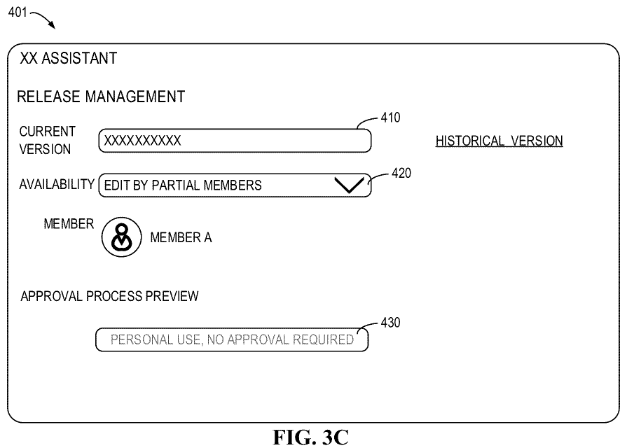

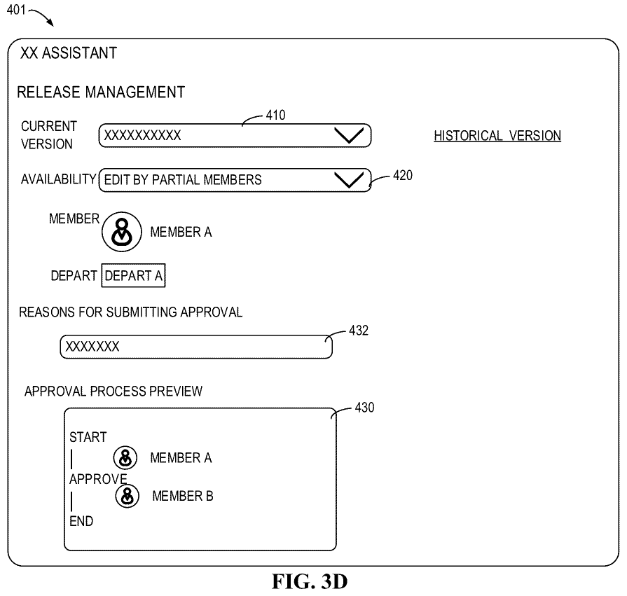

FIG. 3A and FIG. 3B show schematic diagrams of example page of a creation page of a plugin according to some embodiments of the present disclosure;

FIG. 3C to FIG. 3D are schematic diagrams of example page of a release page of a plugin according to some embodiments of the present disclosure;

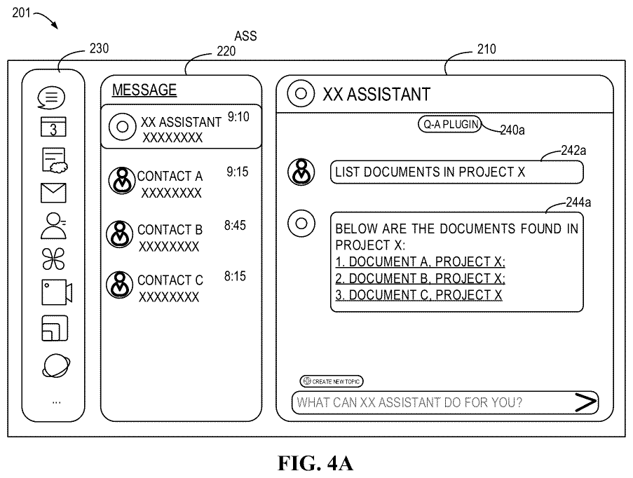

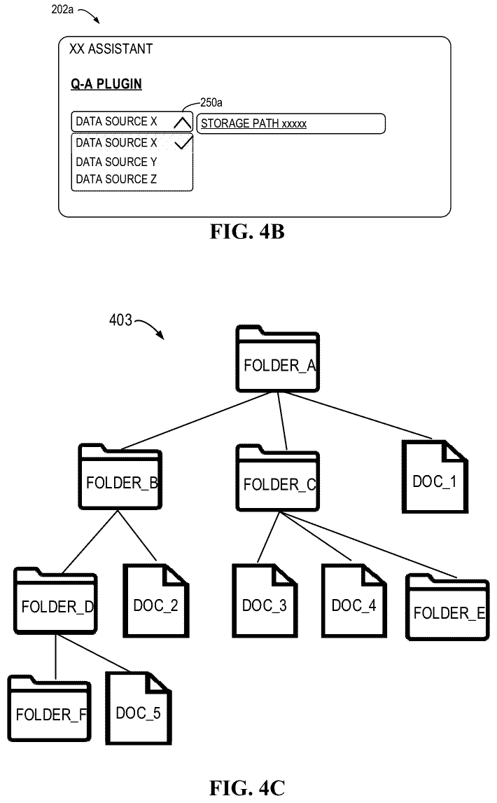

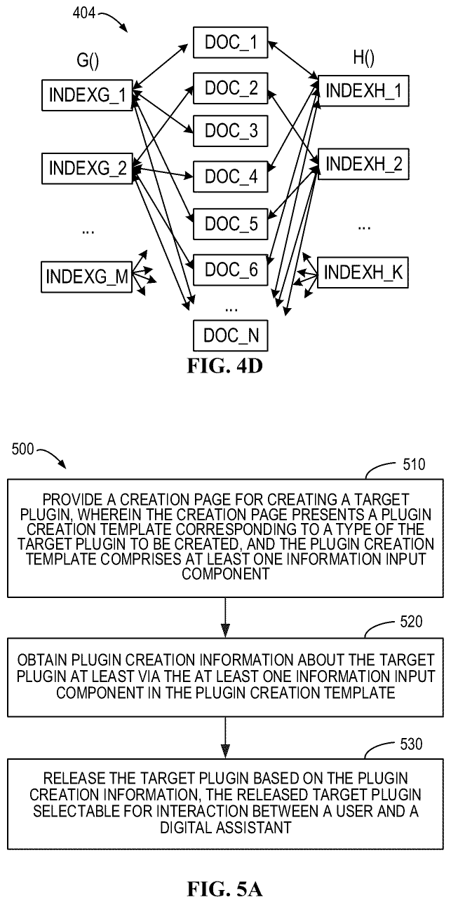

FIGS. 4A-4B illustrate schematic diagrams of example user interfaces of a digital assistant based data query according to some embodiments of the present disclosure;

FIG. 4C is a schematic diagram of an example of a data entity storage tier in a data source according to some embodiments of the present disclosure;

FIG. 4D illustrates a schematic diagram of an example mapping between different indexes and data entities according to some embodiments of the present disclosure;

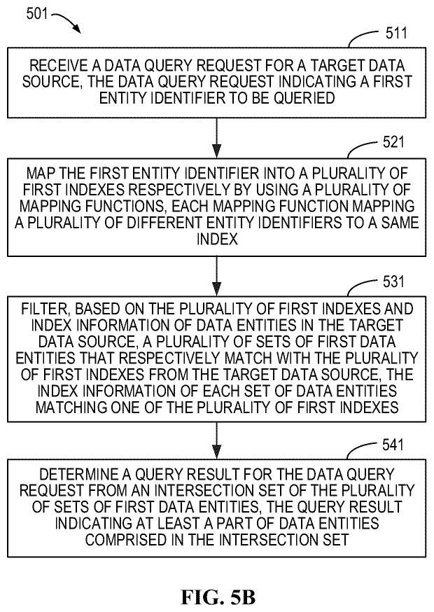

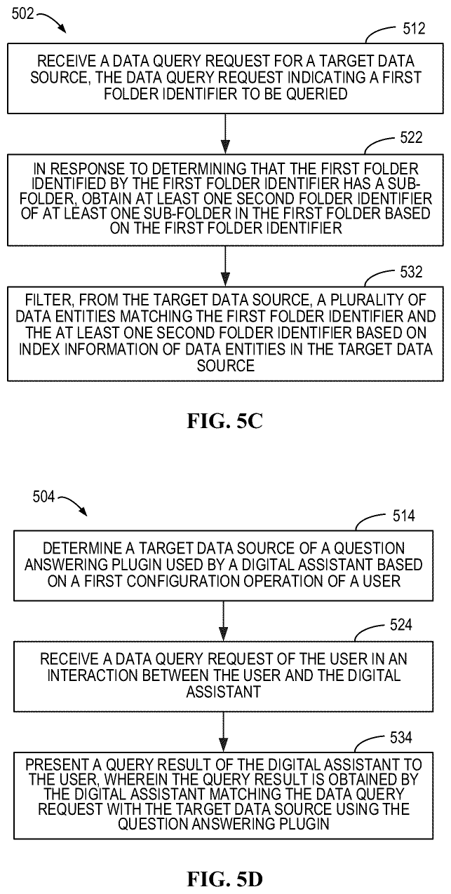

FIG. 5A shows a flowchart of a process for plugin creation according to some embodiments of the present disclosure;

FIG. 5B shows a flowchart of a process for data query according to some embodiments of the present disclosure;

FIG. 5C shows a flowchart of a process for data query according to some other embodiments of the present disclosure;

FIG. 5D shows a flowchart of a process for data query according to still other embodiments of the present disclosure;

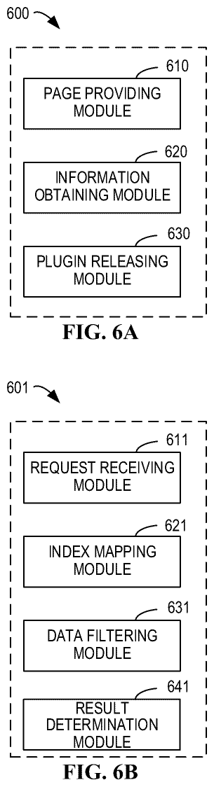

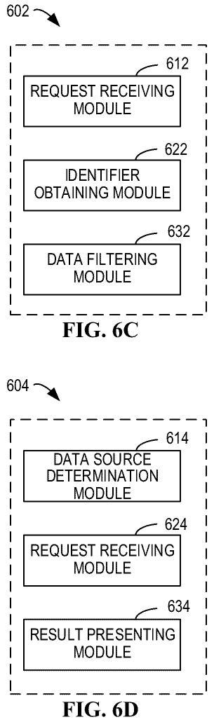

FIG. 6A shows a block diagram of an apparatus for plugin creation according to some embodiments of the present disclosure;

FIG. 6B shows a block diagram of an apparatus for data query according to some embodiments of the present disclosure;

FIG. 6C shows a block diagram of an apparatus for data query according to some other embodiments of the present disclosure;

FIG. 6D shows a block diagram of an apparatus for data query according to still other embodiments of the present disclosure; and

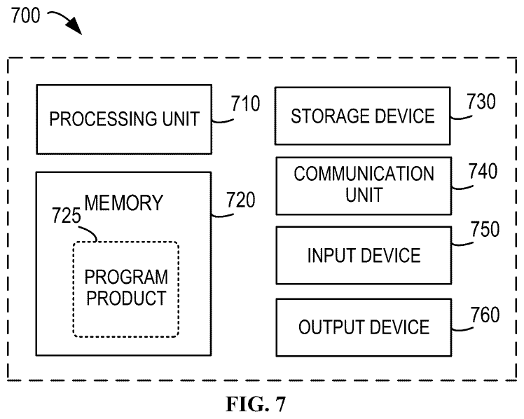

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definition may also be included below.

Herein, unless explicitly stated, “responding to A” performs one step and does not imply that this step is performed immediately after “A”, but may include one or more intermediate steps.

It would be appreciated that the data involved in the technical solution (including but not limited to the data itself, the obtaining, using, storing or deleting of the data) should follow the requirements of the corresponding laws and regulations and related regulations.

It would be appreciated that before using the technical solutions disclosed in the embodiments of the present disclosure, relevant user should be informed of the types, use ranges, usage scenarios, and the like of the information related to the present disclosure in an appropriate manner according to relevant laws and regulations, and the authorization of the related user may be obtained, wherein the relevant users may include any type of entities, such as individuals, services, and groups.

For example, when an active request of a user is received, prompt information is sent to the related user to explicitly prompt the related user, and the operation requested to be performed will need to obtain and use the information of the related user, so that the related user can autonomously select whether to provide information to software or hardware executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select “agree” or “not agree” to provide information to the electronic device.

It would be appreciated that the foregoing notification and obtaining a user authorization process are merely illustrative, and do not constitute a limitation on implementations of the present disclosure, and other manners of meeting related laws and regulations may also be applied to implementations of the present disclosure.

FIG. 1 illustrates a schematic diagram of an example environment 100 in which embodiments of the present disclosure can be implemented. In this example environment 100, a digital assistant 120 and an application 125 are installed in a terminal device 110. A user 140 may interact with the digital assistant 120 and the application 125 via the terminal device 110 and/or an accessory device(s) to the terminal device 110.

In some embodiments, the digital assistant 120 and the application 125 may be downloaded and installed on the terminal device 110. In some embodiments, the digital assistant 120 and the application 125 may also be accessed in other manners, such as web page access. In the environment 100 of FIG. 1, in response to the application 125 being activated, the terminal device 110 may present an interface 150 of a digital assistant 120 and the application 125.

The application 125 may include, but are not limited to, one or more of: a chat applications (also known as instant messaging application), document application, audio/video conferencing application, e-mail application, task applications, calendar application, Objectives and Key Results (OKR) application, and so on. Although a single application is shown in FIG. 1, in practice, a plurality of applications may be installed on the terminal device 110. In some embodiments, the application 125 may include a multifunction collaboration platform, such as an office collaboration platform (also referred to as an office suite), which can provide integration of a plurality of types of applications or components, so that people can conveniently perform activities such as office and communication. In the multifunctional collaboration platform, people can start different applications or components as needed to complete corresponding information processing, sharing, communication and the like.

The application 125 may provide a data entity or data entities 126. A data entity 126 may be a content instance created by the user 140 or other user on the application 125. For example, depending on the type of data supported by the application 125, a data entity 126 may be a document (e.g., a word document, a pdf document, a slides document, a sheet document, etc.), an e-mail, a message (e.g., a session message in an instant messaging application), a calendar, a schedule, a task, an audio, a video, an image, or the like.

In some embodiments, the digital assistant 120 may be provided by a separate application, or may be integrated in some application 125 capable of providing data entities. The application for providing the client interface of the digital assistant may correspond to a single functional application or a multifunction collaboration platform, such as an office suite or other collaboration platform capable of integrating a plurality of components. In some embodiments, the digital assistant 120 supports usage of plugins. Each plugin can provide one or more functions of the application. Such plugins include, but are not limited to, one or more of a search plugin, a contact plugin, a messaging plugin, a document plugin, a table plugin, an e-mail plugin, a calendar plugin, a schedule plugin, a task plugin, and the like.

The digital assistant 120 is a user's intelligent assistant, and has the capability of intelligent dialogue and information processing. In some embodiments of the present disclosure, the digital assistant 120 is configured to interact with the user 140 to assist the user 140 in using the terminal device or the application. An interaction window with the digital assistant 120 may be presented in the client interface. In the interaction window, the user 140 can interact with the digital assistant 120 by inputting natural language to instruct the digital assistant to assist in completing various tasks, including operations on the data entity 126.

In some embodiments, the digital assistant 120 may be included in the contact list of the application as a contact of the user 140, or included in an information flow of the chat component. In some embodiments, the digital assistant 120 may be a personal digital assistant specific to the current user 140, or may be a general-purpose digital assistant.

In some embodiments, a plurality of interaction modes between the user 140 and the digital assistant 120 may be provided, and may be flexibly switched therebetween. If a certain interaction mode is activated, a corresponding interaction area is presented to facilitate the interaction of the user 140 with the digital assistant 120. The interaction ways between the user 140 and the digital assistant 120 in different interaction modes may be different, which can flexibly adapt to the interaction requirements in different application scenarios.

In some embodiments, an information processing service specific to the user 140 may be provided based on historical interaction information of the user 140 with the digital assistant 120 and/or a data range specific to the user 140. In some embodiments, the historical interaction information in interaction between the user 140 and the digital assistant 120 in the plurality of interaction modes may be respectively stored in association with the user 140. As such, in one of the plurality of interaction modes (any one of the interaction mode or a specified one), the digital assistant 120 may provide services to the user 140 based on historical interaction information stored in association with the user 140.

The digital assistant 120 may assist a user in using a terminal device or application. Some applications can provide integrated functionality for different plugins. In addition to the free dialogue with the digital assistant, the user can instruct the digital assistant to complete some more complex operations related to the service of the application by using different plugins through natural language instructions, such as searching for data, creating documents, scheduling invitation, creating tasks, and the like.

The digital assistant 120 may be activated or woken up in any appropriate manner (e.g., via shortcut, button, or voice) to present an interaction window with the user 140. By selecting the digital assistant 1201, an interaction window with the digital assistant 120 may be started. The interaction window may include an interface element for information exchange, such as an input box, a message list, a message bubble, and the like. In some other embodiments, the digital assistant 120 may be activated via an entry control or a menu provided in the page, or may be activated by inputting a predetermined instruction. In some embodiments described below, for ease of discussion, examples will be described with the interaction window of the user and the digital assistant being a conversation window.

In some embodiments, the terminal device 110 communicates with a server 130 to enable provisioning of services to the digital assistant 120 and the application 125. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server 130 may be various types of computing systems/servers capable of providing computing power, including, but not limited to, mainframes, edge computing nodes, computing devices in a cloud environment, and so forth.

It should be understood that the structures and functions of various elements in the environment 100 are described for purpose of example only and do not imply any limitation to the scope of the present disclosure.

As briefly mentioned above, a digital assistant may assist a user in using a terminal device or application. Some applications can provide integrated functionality for different plugins. In addition to the free dialogue with the digital assistant, the user can make the digital assistant complete some more complex operations related to the service of the application by using different plugins through natural language instructions, such as, creating a document, scheduling invitation, creating a task, and the like. Conventionally, the plugins often require relevant professionals (e.g., the background programmers of the applications) to create. This makes the barrier for plugin creation relatively high, so the user cannot perform flexible plugin creation based on its own needs.

According to some embodiments of the present disclosure, an improved solution for plugin creation is presented. In embodiments of the present disclosure, a creation page for creating a target plugin is provided in an interaction window between a user and a digital assistant. The creation page is presented with a plugin creation template. Through at least one information input component in the template, plugin creation information of the plugin is obtained, and a plugin is released based on the plugin creation information. In this way, the user can conveniently and quickly complete the creation of the plugin, thereby allowing the user to efficiently complete diversified operations by use of plugins during the interaction with the digital assistant.

Some example embodiments of the present disclosure will be described in detail below with reference to examples of the accompanying drawings.

As described above, in embodiments of the present disclosure, a digital assistant is configured to interact with a user. An interaction window of the user with the digital assistant may be presented in a client interface. The interaction window between the user and the digital assistant may include a conversation window, and the interaction between the user and the digital assistant in the conversation window may be presented in a form of session messages. Alternatively or additionally, the interaction window of the user and the digital assistant may further include other types of windows, such as a window of a floating window mode, where the user may trigger the digital assistant to perform a corresponding operation by inputting an instruction, selecting a shortcut instruction, or the like. The digital assistant serves as an intelligent assistant, and has an intelligent dialogue and information processing capability. In the interaction window, the user enters an interaction message, and the digital assistant provides a response message in response to the user input. A client interface for providing the digital assistant may correspond to a single functional application or a multifunction collaboration platform, such as an office suite or other collaboration platform capable of integrating a plurality of components.

In some embodiments, a plurality of interaction mode of a user with a digital assistant may be provided, and may be flexibly switched between a plurality of interaction modes. In the case that a certain interaction mode is activated, a corresponding interaction area is presented to facilitate user interaction with the digital assistant. The interaction manners of the user and the digital assistant in different interaction modes are different, which can flexibly adapt to interaction requirements in different application scenarios.

In some embodiments, the digital assistant may be included as a contact of the user, included in a contact list of the current user in the office suite, or included in an information flow of the chat component. In some embodiments, the user has correspondence with the digital assistant. For example, a first digital assistant corresponds to a first user, a second digital assistant corresponds to a second user, and so on. In some embodiments, the first digital assistant may uniquely correspond to the first user, the second digital assistant may uniquely correspond to the second user, and so on. That is, the first digital assistant of the first user may be specific or dedicated to the first user. For example, in a process in which the first digital assistant provides assistance or service for the first user, the first digital assistant may utilize its historical interaction information with the first user, data authorization by the first user that can be accessed, current interaction context of the first digital assistant and the first user, and the like. If the first user is an individual entity or an individual person, the first digital assistant may be considered a personal digital assistant. It would be appreciated that, in the disclosed embodiments, the first digital assistant is operated based on data that is granted permission with the authorization of the first user. It should be understood that the “unique correspondence” or the like in this disclosure is not intended to limit that the first digital assistant will be updated accordingly based on the interaction process between the first user and the first digital assistant.

In some embodiments, an information processing service specific to the user can be provided based on historical interaction information of the user with the digital assistant and/or a data range specific to the user. In some embodiments, the historical interaction information of the user interaction with the digital assistant in the plurality of interaction modes may be stored in association with the user. As such, in one of the plurality of interaction modes (any of the interaction modes or a specified one of the interaction modes), the digital assistant may provide services to the user based on historical interaction information stored in association with the user.

The digital assistant may be activated or wakened up in an appropriate manner (e.g., via a shortcut, button, or voice) to present an interaction window with the user. In some embodiments, the digital assistant may be included in the contact list of the user as a contact of the user, or included in the information flow of the chat application. By selecting the digital assistant, an interaction window with the digital assistant may be started. The interaction window may include an interface element for information exchange, such as an input box, a message list, a message bubble, and the like. In some other embodiments, the digital assistant may be activated through an entry control or a menu provided in the page, or may be activated by inputting a predetermined instruction. In some embodiments described below, for ease of discussion, a conversation window is mainly used as an example of the interaction window of the user and the digital assistant for description.

FIGS. 2A-2C illustrate schematic diagrams of an example client interface 201 in which a plugin creation request is initiated in accordance with some embodiments of the present disclosure. The client interface 201 may be implemented at the terminal device 110. Examples of FIGS. 2A-2C are described below with reference to FIG. 1.

In some embodiments, the terminal device 110 activates the digital assistant in response to a user (for example, the user 140) triggering a predetermined operation (for example, selecting a digital assistant from a contact list), and may present a conversation window (also referred to as a primary conversation window) for interaction between the user and the digital assistant and a plugin selection control. With such a plugin selection control, the user may select a plugin(s) to use in the primary conversation window.

In some embodiments, as shown in FIG. 2A, a primary conversation window between the user and a digital assistant (shown as “XX assistant”) is presented in a region 210 of the interface 201. The digital assistant may be considered as one of contacts of the user, and is presented in the information flow of the instant messaging application. The instant messaging application is presented in a region 230 of the interface 201, and the information flow is presented in a region 220 of the interface 201. The user selects the digital assistant in the instant messaging application to enter the primary conversation window. The primary conversation window includes a plugin selection control 212. The user may select a plugin to use in the conversation window by clicking on the plugin selection control 212.

In some embodiments, a digital assistant in a page (for example, a page browsing a document) may be activated by the terminal device 110 in response to a predetermined operation performed by a user (for example, triggering a predetermined control, inputting a predetermined instruction or a voice wakeup, and the like), and a secondary conversation window that the user interacts with the digital assistant may be presented. This secondary conversation window may also include a plugin selection control. With such a plugin selection control, the user may select and utilize the plugin in the secondary conversation window.

In some embodiments, in response to detecting a selection operation (e.g., a click operation) on the plugin selection control 212, the terminal device 110 may present a plugin selection panel 214. The plugin selection panel 214 is presented with pre-stored at least one plugin that has been created (e.g., a search plugin, a contact plugin, a messaging plugin, and so on as shown in FIG. 2A). In some embodiments, a plugin viewing control 216 is also presented in the plugin selection panel 214. The terminal device 110 may present all plugins included in the terminal device 110 in response to detecting a selection on the plugin viewing control 216.

In some embodiments, in response to detecting a selection on the plugin viewing control 216, the terminal device 110 may also present a plugin settings page in the interface 201. For example, as shown in FIG. 2B, in response to detecting a selection operation on the plugin viewing control 216 in FIG. 2A, the terminal device 110 may also present a plugin settings page 240 in the interface 201. An example in which only the plugin settings page 240 is presented on the upper side of the interface 201 and included in the interface 201 is taken as an example in FIG. 2B. In other embodiments, they may be arranged in other manners as required. For example, it may switch to the plugin settings page 240 from the interface 201.

In some embodiments, a plugin search function is provided in the plugin settings page 240 for searching for plugins from existing plugins. As shown in FIG. 2B, the plugin settings page 240 includes a search box 242. The user may enter at least a portion of the name of a plugin to be searched in the search box 242. In some embodiments, the plugin settings page 240 may present search results in association with the search box 242. For example, if the user input received in the search box 242 is “search,” the plugin settings page 240 may present search results in association with the search box 242, such as “search plugin”, “search contact”, “search document”, “search table”, etc. Additionally or alternatively, the plugin selection panel may provide a fuzzy search function.

In some embodiments, the plugin settings page 240 may also include a control 243 and a control 244. The terminal device 110 may, for example, in response to detecting a selection operation on the control 243, present all the stored plugins (which may be referred to as a first set of plugins) in the plugin settings page 240. For example, as shown in FIG. 2B, in response to detecting a selection operation on the control 243, the terminal device 110 presents all stored plugins, including Plugin 1, Plugin 2, and Plugin 3 at “Current Plugin”. All the plugins herein may be created by the user himself, or may be created and shared to the user by other users. For example, the terminal device 110 may only present, in the plugin settings page 240, plugins (for example, may be referred to as a second set of plugins) created by the current user in response to detecting a selection operation on the control 244. It would be appreciated that the first set of plugins may include the second set of plugins, and the number of plugins included in the first set of plugins may be greater than or equal to the number of plugins included in the second set of plugins. In some embodiments, in response to the plugin settings page 240 being presented, the terminal device 110 may by default present the first set of plugins corresponding to the control 243, and switch to presenting the second set of plugins after detecting the selection operation on the control 244.

In some embodiments, the plugin settings page 240 may also include a plugin creation region 245. The plugin creation region 245 may be used, for example, to present a text description indicating that the user created the plugin. The plugin creation region 245 may also be presented with a plugin creation control 246. For example, the terminal device 110 may present a creation page of the plugin in response to detecting a selection operation on the plugin creation control 246. In some embodiments, before presenting the creation page of the plugin, the terminal device 110 may further present, in response to detecting a selection operation on the plugin creation control 246, a type selection page for selecting a plugin type of the plugin to be created. For example, as shown in FIG. 2B and FIG. 2C, the terminal device 110 may, for example, present a type selection page 250 in response to detecting a selection operation on a plugin creation control 246. Similar to the plugin settings page 240, the manner in which only the type selection page 250 is presented on the upper side of the interface 201 and included in the interface 201 in FIG. 2C is taken as an example for description. They may be arranged in other manners as required in other embodiments.

As shown in FIG. 2C, the type selection page 250 includes a plurality of types of selection areas corresponding to different plugin types. In some embodiments, considering that intelligent question answering are a quite common demand scenario for a user, and the process of knowledge question answering is composed of two key parts of a search vector recall and model generating answers in an implementation, the links of different scenarios can be highly reused. In view of this, a question answering plugin may be configured as an application scenario in the creation process of digital assistant plugin, to lower the barrier in configuring question answering plugins, and enable the user to quickly create one or more question answering plugins for use. Therefore, in some embodiments, the type selection page 250 includes at least a selection region 252 corresponding to a question answering (Q-A) type plugin template and a creation control 253 for plugin creation corresponding to the question answering type plugin template. In addition to the question answering plugin, examples of other plugin types may include, but are not limited to, a document type plugin, a custom plugin, an e-mail type plugin, a search type plugin, and the like.

As an example, in FIG. 2C, the plurality of types of selection areas included in the type selection page 250 may include, for example, a selection region 252 corresponding to the question answering type plugin template, a selection region 254 corresponding to the document type plugin template, and a selection region 256 corresponding to the custom plugin. It would be appreciated that more regions corresponding to other template types may also be included in the type selection page 250, which is not limited in the present disclosure. Each region includes a creation control associated with a corresponding plugin type. For example, the region 252 includes a corresponding creation control 253 to create a plugin corresponding to the question answering plugin template; the region 254 includes a creation control 255 to create a plugin corresponding to the document plugin template; and the region 256 includes a creation control 257 for flexible customization by the user.

In some embodiments, in response to detecting a selection operation on a creation control in a window corresponding to any type, the terminal device 110 determines to receive a plugin creation request for a plugin of the type, and further provides a creation page for creating the plugin based on the plugin creation request. For example, in response to detecting a selection operation on the creation control 253 in FIG. 2C, the terminal device 110 determines to receive a plugin creation request indicating to create a question answering type plugin, and further provides a creation page for creating a question answering type plugin. In response to detecting a selection operation on the creation control 255 in FIG. 2C, the terminal device 110 determines to receive a plugin creation request indicating to create a document type plugin, and further provides a creation page for creating a document type plugin. In response to detecting a selection operation on the creation control 257 in FIG. 2C, the terminal device 110 determines to receive a plugin creation request indicating to create the customized plugin, and further provides a creation page for creating the customized plugin.

It should be understood that FIGS. 2A-2C illustrate example interfaces for initiating a plugin creation request, including for initiating a template-based plugin creation request. In a specific application, any interface interaction manner may be designed as required, or a plugin creation entry may be provided in any other appropriate page, to facilitate the user to initiate the plugin creation request.

In embodiments of the present disclosure, in order to facilitate a user to create a plugin more efficiently, one or more types of plugin creation templates are provided. If the user requests to create a template according to a specific type of plugin to perform the plugin creation, the creation page for creating the plugin includes a plugin creation template corresponding to the type of the plugin to be created. The plugin creation template includes at least one information input component. In some embodiments, the plugin creation template herein is determined based on template information corresponding to the type. The template information herein indicates at least one information input component required to create a plugin to the type. Therefore, the user may determine the corresponding template information based on the plugin type expected to be created by the user, and further determine the creation page including the corresponding plugin creation template.

In some embodiments, depending on the type of plugin to be created, the information input component(s) provided by the corresponding plugin creation template may include a list of tools selectable under the type. In general, a plugin may be considered as a collection of functions, while a “tool” in a plugin may be considered as a unit function or an atomic function in the plugin. With a plurality of tools, the plugin can ultimately be used to handle a type of tasks desired by the user. For example, a plugin for processing a document may include a document creation tool for creating a new document; a search tool for performing searching in a document; an equation generation tool for generating and inserting an equation in a document, and so on.

When chatting with the digital assistant, the user may select a question answering type plugin to enable the digital assistance to get the capability of answering the user's questions. In some embodiments, a plugin creation template corresponding to the question answering plugin may be provided. For the question answering plugin, one of the required tools includes a dataset(s).

A dataset herein may include, for example, data required by a user to enable the digital assistant to perform questioning and answering. For example, for employees in an enterprise, the datasets in the question answering plugin may include information in one or more aspects such as regulations, operational procedures, service precipitation, and the like within the enterprise. The dataset may be in any format, including offline documents, online documents, knowledge spaces, Frequently Asked Questions (FAQ) documents, documents of various formats (e.g., PDF, word, PPT, etc.), and the like. Traditionally, employees need to know knowledge of these enterprises for work purposes or other transactional reasons (such as to know how a certain internal service is docked, how to apply for vacation, how to provide a reimbursement, etc.), and employees often need to look up data through different channels or query the related colleagues. Such an information obtaining manner takes a lot of time to find information and summarize the answer to the questioner, and also takes time and effort to solve a large number of repeated questions for the answerer. To solve such a problem, in embodiments of the present disclosure, corresponding knowledge information, for example, a dataset including the knowledge information, may be provided to a digital assistant. These datasets are used to generate a question answering plugin for the digital assistant. Therefore, the user can directly provide various questions to the digital assistant, and the digital assistant can use the question answering plugin to generate a solution for the user based on the knowledge information included in the datasets, which can greatly improve the efficiency of the question answering scene. In addition, when creating the question answering type plugin, the user may not need to pay attention to the technical details, but only pay attention to provide the basic information (that is, the plugin creation information) through the plugin creation template, so that the configuring process of the question answering plugin can be templated with zero-coding, so that the user can quickly create a customized question answering plugin for use in the digital assistant with extremely low cost.

In some embodiments, for the plugin creation template corresponding to the question answering plugin, in addition to the user-configurable dataset, the plugin creation template may be pre-configured with the question answering capability information required to provide the question answering function. Such question answering processing capability information and the user configured datasets together constitute the plugin creation information for creating the question answering plugin of the user. For example, the question answering processing capability may include an indexing capability for the datasets, a comprehension capability of the user questions, and a capability of searching for an answer corresponding to the question from the datasets. In this way, after the user inputs one or more datasets through the plugin creation template, the datasets are indexed into a knowledge base for the question answering plugin. The created question answering plugin is able to search for an answer corresponding to a question within the range of knowledge base.

It should be understood that, in addition to the question answering type plugin, for other types of plugins, a corresponding plugin creation template may be provided according to the requirements in creating some specific types of plugins. In a plugin creation template, different information input components can be provided according to the plugin type, so that the user can complete coding of the whole plugin or the tools in the plugin without complex programming, so that various plugins satisfying the custom requirements can be simply and conveniently defined. In some embodiments, depending on the specific type, the plugin creation template may also be pre-configured with the plugin processing capability information required by the plugin of the corresponding type to indicate the plugin processing capability commonly required by the plugin of the type. The plugin processing capability information may be built into the plugin creation template without requiring user specific input and configuration. The plugin processing capability information pre-configured in the plugin creation template together with the information input by the user constitutes the plugin creation information for creating the user-customized plugin.

In some embodiments, to differentiate among a plurality of plugins, regardless of which plugin type creation page is created, each plugin creation template may include at least one of an information input component (which may also be referred to as a second information input component) to input identification information (for example, a text identifier and/or an image identifier) of the plugin and an information input component (which may also be referred to as a third information input component) to input description text of the plugin. The terminal device 110 may obtain, via at least one information input component in the plugin creation template, plugin creation information about the plugin to be created.

FIGS. 3A and 3B illustrate schematic diagram diagrams of example creation pages of a plugin according to some embodiments of the present disclosure. In some embodiments, in response to detecting a selection operation on a creation control (for example, the creation control 253 in FIG. 2C) associated with the question answering type plugin, the terminal device 110 may present a creation page 301 including a plugin creation template for creating the question answering type plugin as shown in FIG. 3A. In some embodiments, in response to detecting a selection operation on a creation control corresponding to a non-question answering type plugin (for example, the creation control 255 in FIG. 2C), the terminal device 110 may present a creation page 302 including a plugin creation template for creating the non-question answering type plugin as shown in FIG. 3B.

As shown in FIG. 3A and FIG. 3B, both the creation page 301 and the creation page 302 include an information input component 310 to input an image identifier (for example, an icon) of the plugin, an information input component 320 to input a text identifier (for example, a name) of the plugin, and an information input component 330 to input description text. The information input component 310 and the information input component 320 are both information input components for inputting identification information of the plugin. The terminal device 110 may obtain the icon of the plugin via the information input component 310, obtain the name of the plugin via the information input component 320, and obtain the introduction text of the plugin via the information input component 330. In some embodiments, for the image identifier of the plugin, the terminal device 110 only supports obtaining the image in the specified format through the information input component 310. For example, the terminal device 110 only supports obtaining an image in the PNG format through the information input component 310. In this case, the user may click text such as “image format requirements” to view the format requirement for the image identifier. The terminal device 110 may present, in response to detecting a click operation on the “image format requirement”, a description text indicating the format requirement.

In some embodiments, the creation page 301 and the creation page 302 may further include an effect presentation area 340 for presenting plugin preview information. The effect presentation area 340 may present a preview effect of the plugin to be created. In some embodiments, the creation page 301 and the creation page 302 may further include an information input component for determining permission information of the plugin. Such permission information may, for example, indicate a range of users accessible to the plugin. For example, if the terminal device 110 obtains the identification information (for example, the name of the user A) corresponding to the user A through the information input component, the terminal device 110 may determine that the user A may use the plugin.

In some embodiments, as shown in FIG. 3A, if the plugin to be created is a question answering plugin, the creation page 301 may further include an information input component 350 (also referred to as a first information input component) for specifying one or more datasets corresponding to the question answering plugin. Such information input component 350 may include, for example, a first portion configured to input a type of one or more datasets and a second portion configured to input a source(s) of one or more datasets. For example, as shown in FIG. 3A, the information input component 350 includes an input entry 352 for inputting a dataset type and an input entry 354 for inputting a dataset source. The dataset type herein may be, for example, web, wiki, etc., and the dataset source herein may be, for example, an access address to such a dataset. In some embodiments, such an input entry 352 and an input entry 354 may be used to receive at least one type of dataset and at least one dataset source corresponding to the at least one type of dataset. Alternatively or additionally, in some embodiments, such an input entry 352 and an input entry 354 may also be used to receive only one type of dataset and a dataset source corresponding to the dataset. In this case, an input entry 352 and an input entry 354 may be considered as a group, and a plurality of groups of such input entries may be included in the information input component 350 to obtain a plurality of types of datasets and respective dataset sources corresponding to the plurality of types of datasets. In some embodiments, the information input component 350 further includes a dataset adding control 356. The terminal device 110 may, for example, in response to detecting the selection operation on the dataset adding control 356, obtain the dataset determined based on the information input via the input entry 352 and the input entry 354. It would be appreciated that depending on different obtained datasets, the corresponding created question answering plugins may be created with different specific question answering capabilities.

In some embodiments, as shown in FIG. 3B, if the plugin to be created is a non-question answering plugin, the creation page 302 may further include an information input component 360 to specify one or more tools corresponding to the non-question answering plugin. The information input component 360 may include a search box 362. The terminal device 110 may search for a plurality of tools based on the user input obtained in the search box 362. The information input component 360 may also include a tool creation control 364. The terminal device 110 may present a creation page for creating a new tool in response to detecting a selection operation on the tool creation control 364. A plurality of pre-obtained tools may be presented in the information input component 360, which may also be pre-created by the user, or created and shared to the user for use by other users. The plurality of tools may be presented in the information input component 360 in a list of tools. A tool name, tool description, and operation corresponding to each tool may be presented in the tool list. The operations herein may include, for example, an edit operation and a delete operation. The tool list of the information input component 360 may include, for example, controls corresponding to the operations, such as “edit control” and “delete control”. The terminal device 110 may perform a corresponding operation on the tool in response to detecting a selection operation on a certain control. For example, the terminal device 110 may determine to perform an edit operation on Tool 1 in response to detecting a selection operation on an edit control of Tool 1. In some embodiments, the terminal device 110 may present a respective page for performing an operation, such as an edit page for performing an edit operation on a tool.

The terminal device 110 may release the plugin based on the plugin creation information, which may be selectable for interaction between a user and a digital assistant. FIGS. 3C-3D illustrate schematic diagram diagrams of an example release page 401 for a plugin according to some embodiments of the present disclosure. In some embodiments, in response to the plugin creation information of the plugin being obtained in the creation page, the terminal device 110 may present the release page 401 for releasing the plugin. An input entry 410 for entering version information is presented in the publication page 401. In some embodiments, the version number of the latest version of the plugin may be directly presented in the input entry 410. The version number herein may be determined by the terminal device 110, or may be manually input by the user. In some embodiments, the terminal device 110 may further present a control of “historical version” in association with the input entry in the release page. The terminal device 110 may present, in response to detecting a click operation on the control of “historical version”, historical version information associated with the plugin to be released.

In some embodiments, the publication page 401 also includes a permission edit control 420. The terminal device 110 may determine, based on the user input obtained at the permission edit control 420, that a range of users that may use the plugin, that is, determine at least one user that can use the plugin. The at least one user here includes at least the current user who creates the plugin.

In some embodiments, if the plugin is created for personal use, i.e., only used by the user who created the plugin, only user information associated with the current user is presented in the publication page 401. For example, as shown in FIG. 3C, if the current user is user A, the terminal device 110 only presents the user information of user A (for example, the avatar, the name, and the like of user A) associated with the permission edit control 420. In some embodiments, where the created plugin is used for public use, i.e., where the user creating the plugin is used with at least one further user, the release page 401 may also present user information associated with all users who may use the plugin. For example, as shown in FIG. 3D, if the current user is user A, and the plugin created by user A is accessible by all users in the department of user A, the terminal device 110 may present the user information of user A (for example, the avatar and the name of user A) associated with the permission edit control 420 and the department information (for example, the department name) of user A's department. It would be appreciated that, in addition to presenting the department information, in some embodiments, the terminal device 110 may also present the user information of user A and the user information of all users of user A's department in association with the permission edit control 420. In this case, the digital assistant may provide different responses to different queries based on the permission of the questioner. For example, if user A only has the permission of Plugin A, and user B only has the permission of Plugin B, the digital assistant replies to user A by using Plugin A, and replies to user B by using Plugin B. Even if user A and user B ask the same question for the digital assistant, the responses from the digital assistant pair may be different because they have different permissions.

In some embodiments, the user-created plugin may be released to other users for use. In some embodiments, the plugin to be released by the user may be released after the approval. In this case, the terminal device 110 may release the plugin in response to approval of the plugin creation information. In some embodiments, to enable the user to intuitively obtain the current approval status of the plugin (for example, whether to issue the approval), as shown in FIG. 3C and FIG. 3D, the release page 401 may further include an approval information presentation area 430. In the case where the created plugin is used for private use, the approval information presentation area 430 may present a text prompt as shown in FIG. 3C, and the text prompt here is used to prompt the user that such a plugin does not need to be audited by others, and may be directly released. When the created plugin is used for public use, the approval information presentation area 430 may present the approval information as shown in FIG. 3D. The approval information herein may indicate the auditor of the approval plugin (the auditor herein includes other users or machines, models, digital assistants, etc.), and the current approval node. The terminal device 110 may present the prompt information to the user in response to the end of the review. For example, the prompt information may be presented to the user by voice, vibration, text, or the like. In response to detecting a releasing operation indicating a releasing plugin (for example, a touch operation such as a click operation on a releasing control, or a non-touch operation of a voice instruction and a posture instruction), the terminal device 110 may, in turn, determine that a release instruction for the plugin is received, and then release the plugin.

In summary, according to some embodiments of the present disclosure, in an interaction window between a user and a digital assistant, a creation page for creating a target plugin is provided. The creation page is presented with a plugin creation template. At least one information input component in the template is created via the plugin, plugin creation information of the plugin is obtained, and the plugin is released based on the plugin creation information. By means of the template, the user can conveniently and quickly complete the plugin creation, and the user can efficiently complete diversified operations by means of the plugin in the interaction process with the digital assistant.

In an application scenario of data searching, the user input is usually used to determine information of a data entity expected to be searched by a user, for example, an identifier of some data entities to be searched in a data source. In order to improve the data filtering efficiency, index information is also constructed for each data entity in the data source. For different data sources, separate index information can be constructed, thereby realizing filtering of different data sources. In the same data source, more fine-grained index information may also be constructed to implement quick search at different granularities. For example, in one data source, an index field may be constructed at a granularity of a data entity to implement data filtering in terms of data entities. In addition, the index information may also be constructed according to a parent node of a data entity, for example, a folder granularity where the data entity is located, so that data filtering can be performed in terms of folders. The construction of the index information may have impacts on the data filtering efficiency, the storage space of the index information, and so on. Therefore, a more efficient way of data query is needed.

In the digital assistant-based interaction, the user may also perform question and answering related to data queries with the digital assistant. The user may provide an input question into the digital assistant which may automatically determine a response to the question and present the response to the user. In this way, the user may obtain the desired answer through natural language input in the interaction window with the digital assistant. In a scenario involving data searching, it is also desirable to achieve data query through question answering with the digital assistant. It is a challenge to achieve more efficient data filtering in such a question answering scenario.

According to embodiments of the invention, an improved solution for data query is provided. In some embodiments of the present disclosure, in an interaction between a user and a digital assistant, a data query request of a user is received, where the data query request indicates a data identifier to be queried. A set of data entities to which the user has permission may be determined from a target data source accessible to the digital assistant. At least one data entity matching the data identifier is filtered from the set of data entities based on index information of the target data source. The at least one determined data entity is presented to the user. According to the solution, the accessible data source can be provided for the digital assistant, to enable the construction capability of the question answering data source by the user as needed. In this way, the user can achieve more targeted question answering interaction, and the quality of the question answering is improved.

In some embodiments of the present disclosure, a data query request for a target data source is received, where the data query request indicates a first entity identifier to be queried. The first entity identifier is mapped into a plurality of first indexes by using a plurality of mapping functions, where each mapping function maps a plurality of different entity identifiers to a same index. Based on the plurality of first indexes and index information of data entities in the target data source, a plurality of sets of first data entities that match the plurality of first indexes respectively are filtered from the target data source, where index information of each set of data entities matches one of the plurality of first indexes. Then a query result for the data query request is determined from an intersection set of the plurality of sets of first data entities, the query result indicating at least a part of data entities included in the intersection set. It is possible to bypass the restriction on the enumerated value of the index field by mapping a large number of entity identifiers in a data source to a small number of index values with more than one mapping function. In addition, the mapping of those mapping functions is ingeniously utilized to filter out data entities not matched with the user query from the intersection set of different indexes, to provide accurate data query results.

In some embodiments of the present disclosure, a data query request for a target data source is received, the data query request indicates a first folder identifier to be queried. In response to determining that a first folder identified by the first folder identifier has a subfolder, at least one second folder identifier of at least one subfolder in the first folder is obtained based on the first folder identifier. Based on index information of data entities in the target data source, a plurality of data entities matching with the first folder identifier and the at least one second folder identifier are filtered from the target data source. The index information of each data entity includes at least a folder field indicating the first folder identifier and a folder identifier of the at least one second folder identifier. In this way, for a data source with a large number of folder hierarchy levels with a large depth, there is no need to separately store index information corresponding to all folders in which each data entity is located, thereby greatly reducing the storage space. Meanwhile, during data filtering, by obtaining all subfolder lists with a certain cost of time, data entities under the folders can be easily filtered out.

Some example embodiments of the present disclosure will be described in detail below with reference to examples of FIG. 2A and FIGS. 4A-4D.

In some embodiments, in response to detecting a selection operation (e.g., a click operation) on the plugin selection control 212, the terminal device 110 may present the plugin selection panel 214. The plugin selection panel 214 includes at least one optional plugin, such as a question answering plugin. The user may interact with the digital assistant as needed. If the user desires to perform a data query with the digital assistant, a question answering plugin may be selected.

In some embodiments, if the user has the intent of a data query, the user may select the question answering type plugin for use, to allow the digital assistant to have the capability of question and answering when interacting with the digital assistant. As shown in FIG. 4A, in interaction with the digital assistant, the user may select the document plugin 240a to initiate a conversation. Of course, it should be understood that the plugin selection process shown in FIG. 2A and FIG. 4A is only an example, and the selection step of the question answering plugin may be skipped in the interaction with the digital assistant. Instead, the default digital assistant may by default have the question answering capability corresponding to the question answering plugin.

The knowledge-based question answering process may mainly include two parts: search vector recall and model generating answer. In an interaction between a user and a digital assistant, the terminal device 110 receives a data query request of the user, where the data query request indicates a data identifier to be queried. In some embodiments, the user may input the data query request in various ways where the query target may be explicitly indicated, for example, a name of a data entity to be queried, an access link, or a keyword. Upon receiving the user input, the digital assistant 120 may determine the user intent with the use of the model, so as to determine the data identifier the user desires to query. The data identifier here may include, for example, an entity identifier(s) of one or more data entities, that is, the user expects to find one or more specific data entities. The entity identifier refers to an identifier, such as a document identifier (Doc ID), that identifies the data entity in a data source. In some embodiments, the data identifier in the data query request may further include a folder identifier to be queried, that is, the user expects to find all data entities under a certain folder. The folder identifier is used to identify a certain folder in the data source.

After the query target, that is, the data identifier to be queried, is determined from the data query request, the digital assistant 120 may filter at least one data entity matching with the data identifier to be queried from the target data source by use of the question answering plugin or the question answering capability, and present the at least one determined data entity to the user. For example, in the example of FIG. 4A, the user input enters a message 242a in a conversation window with the digital assistant to request searching for “documents in project X.” Depending on the data source used, the digital assistant 120 may determine that the document keyword relates to documents of “project X” and use the entity identifiers of those documents to filter the corresponding documents from the data source. The digital assistant 120 may list the filtered documents in a message 244a.

In embodiments of the present disclosure, in a question answering scenario of a user and a digital assistant, in order to implement a user-specific data query, the digital assistant is configured with an accessible data source. In some embodiments, for a question answering type plugin, one of the required tools may include a data source. The data source herein may include, for example, data required by the user to allow the digital assistant to perform question and answer. For example, for employees in an enterprise, the data source in the question answering plugins may include information about regulations, operational procedures, service precipitation, and the like within the enterprise. The data source may be in any format, including offline documents, online documents, knowledge spaces, frequently-asked-questions (FAQ) documents, documents of various formats (e.g., PDF, word, PPT, etc.), and the like.

In some embodiments, the target data source accessible to the digital assistant is a question answering plugin that is configured to be used by the digital assistant to perform the question and answering. For example, a data source containing the desired knowledge information may be provided to the digital assistant. Therefore, the user may directly provide various questions to the digital assistant, and the digital assistant may use the question answering plugin to provide a solution to the user based on knowledge information included in the data source, which can greatly improve the efficiency in the scenario of question and answering.

In some embodiments, the target data source to be used may be defined autonomously by the user at a time during the use of the question answering plugin. During interaction of the digital assistant, a first configuration operation of a user interaction with the digital assistant may be received. The target data source of the question answering plugin used by the digital assistant is determined based on the first configuration operation of the user. As shown in FIG. 4B, in a configuration interface 202a of the question answering plugin of the digital assistant, a data source selection box 250a may be provided for the user to select a target data source accessible to the digital assistant or the question answering plugin in the interface.

Then, in the interaction between the user and the digital assistant, a data query request of the user is received. A query result of the digital assistant is presented to the user, where the query result is obtained by the digital assistant which matches the data query request with the target data source using the question answering plugin.

In some embodiments, the user may further configure the online data source as the target data source. For example, the configured target data source may include one or more online documents. In this way, as the document(s) is updated online, the question answering plugin may always determine the query result for the user based on the latest document content.

In some embodiments, the selection of the part of data sources to be used for the question answering may be additionally completed in the configuration phase of the question answering plugin, for example, configured by the creator of the question answering plugin.

In some embodiments, for data security, when a result of the data query request is determined, a set of data entities to which the user has permission is determined from a target data source accessible to the digital assistant, and at least one data entity matching with the data identifier is filtered from the set of data entities based on index information of the target data source.

The permissions of the user may also be considered for configuring the data source to be used. Data entities with user permission may be allowed for user data queries and be presented to the user. The permission here may be a read permission, a query permission, or the like.

After the target data source to be queried is determined, and the set of data entities with the permission of the user are determined from the target data source, at least one data entity matching with the data identifier may be further filtered from the set of data entities using the data identifier based on the index information constructed for the set of data entities. For example, the data identifiers may be mapped into corresponding indexes in a same index construction manner, and a corresponding index may be located from the set of data entities with a data filter, then the data entity referenced to by the index is filtered.

In some embodiments, for different data sources, separate index information may be constructed, thereby implementing data filtering on different data sources. In some embodiments, within the same data source, the data entities may be stored at a specific hierarchy, so that index information of different granularities may also be built in the data source. Depending on the manner in which the index information is constructed in the data sources, the filtering granularity supported by the data sources may be different.

FIG. 4C is a schematic diagram of an example of a storage hierarchy 403 of a data entity in a data source according to some embodiments of the present disclosure. In this example, it is assumed that the data source is a document library. As shown, in the storage hierarchy 403, the highest tier root folder has a folder identifier “Folder_A,” which may store one or more folders (also referred to as subfolders) and/or one or more documents, identifier by the folder identifiers “Folder_B” and “Folder_C” and the document identifier “Doc_1”, respectively. Similarly, each folder may further store its own subfolders and/or documents, and so on. Note that while the term “folder” is used herein, in the definition of different data sources, the terms “directory,” “node,” “space,” “library,” and the like may also be used to represent a collection capable of storing a plurality of data entities at next hierarchical levels. Note that only one example of storage hierarchical levels is provided in FIG. 4C, and the storage hierarchy may be more complex in practical applications.

In a data source stored in a hierarchical way, for an individual data entity therein, index information in the granularity of entities may be stored when constructing the index information. Specifically, a field may be defined to store an index (or index value) corresponding to an entity identifier of each data entity. In this way, data retrieval in the granularity of data entities may be achieved during data query. For example, by setting the filter condition “Doc_ID=Doc_1, Doc_2”, the documents corresponding to the identifiers may be retrieved based on the index information. In some cases, it may also be desirable to support coarser-granularity data retrieval, such as to retrieve in the granularity of folder so as to retrieve all data entities under a certain folder at one time. To implement indexing in different granularities, a corresponding granularity needs to be stored as a field in the index information, and all data entities at corresponding granularities are obtained by using the per-field filtering capability provided by the data filter. For example, to support retrieval of folder granularity, the indexes corresponding to the folder identifiers may be separately defined for each data entity in all the index information.

However, there are some problems with current indexing approaches. First, the enumerated values of index fields supported by the filter are all upper bounded. For example, a filter supporting a 64-bit integer (int64) field requires that the enumerated value of a single field cannot exceed 20 million. However, as data grows, the number of data entities or higher-hierarchy storage entities in a single data source may exceed the upper bound of the enumerated value. If the data source is directly stored as an index field (e.g., an identifier of a data entity or an identifier of a storage entity at its higher level), it fail to index all data entities or higher-hierarchy storage entities directly into a single index field. At present, the index of the data entity is indexed in slices. For example, if one data source has 0.2 billion+documents, 12 index slices are divided, and an index field corresponding to each index slice may only be used to index no more than 20-million documents. However, in this way, on one hand, it still fails to solve the problem of the continuously increasing number of documents; on the other hand, more and more index slicing only occupy more storage space, but also lower the index efficiency because the final result may be determined only by filtering the index slices one by one at a time.

Second, if the storage hierarchical levels of the data source is too mange, for a single data entity, more index fields may need to be configured to support index of different granularities. For example, in the example of FIG. 4C, for a document with the document identifier “Doc_5”, in addition to the index field corresponding to the document identifier, three more folder fields need to be stored, to respectively store a folder identifier “Folder_D” corresponding to a folder where “Doc_5” is located, and a parent folder “Folder_B” where “Folder_D” is located and a parent folder “Folder_A” where “Folder_B” is located. In this way, when the folder “Folder_A”, “Folder_B” or “Folder_D” are queries, all the documents under the corresponding folder are directly filtered through the corresponding folder field. Similarly, for the document “Doc_2”, it is also necessary to additionally store two folder fields for storing the folder identifiers “Folder_B” and “Folder_A” corresponding to the folders where “Doc_2” is located.

In fact, FIG. 4C is merely a simple example of storage hierarchical levels, and in actual data sources, there may be up to 100 or more parent folders for some data entities. Considering the number of data entities, the storage of these folder fields greatly increases the memory occupation of the index. On the other hand, the enumerated value supported by a single filter is also upper bounded (e.g., to 5000) when querying, otherwise the query efficiency may be greatly reduced. Therefore, if the capability of the field filtering provided by the data source filter itself is directly used, it is impossible to achieve filtering at the granularity of data entity.

In some embodiments of the present disclosure, for the problem of upper limit on the enumerated value of the index field, it is proposed to construct an index corresponding to an entity identifier by using a plurality of many-to-one mapping functions, instead of directly using the entity identifier as an index. Specifically, for a data entity in a target data source, an entity identifier of the data entity is mapped into a plurality of indexes by using the plurality of mapping functions. Each mapping function is configured to map a plurality of different entity identifiers to a same index. In this way, a plurality of data entities identified by a plurality of different entity identifiers may be indexed by the same index (index value). In this way, a plurality of indexes obtained by using the plurality of mapping functions are respectively stored in a plurality of index fields (sometimes referred to as “folder fields”) of the data entity to serve as index information of the data entity.

In some embodiments, the plurality of mapping functions may be a plurality of different hash functions. In some embodiments, two different mapping functions, such as two different hash functions, may be selected to perform the mapping. For example, a document identifier Doc_x of a certain document may be respectively hashed into two indexes G (Doc_x) and H (Doc_x) by using two hash functions G ( ) and H ( ) and then two indexes G (Doc_x) and H (Doc_x) are respectively stored in two index fields G and H.

Since a mapping function performs many-to-one mapping, the number of indexes obtained after the mapping of the single mapping function may be much smaller than the number of data entities in the target data source, to avoid exceeding the upper limit of the enumerated value of the index field.

FIG. 4D illustrates a schematic diagram of an example mapping 404 between different indexes and data entities according to some embodiments of the present disclosure. As shown, document identifiers “Doc_1”, “Doc_3”, and “Doc_5” are hashed by hash function G ( ) to a same index IndexG_1, document identifiers “Doc_2”, “Doc_4”, and “Doc_6” are hashed by hash function G ( ) to another index IndexG_2, and so on. In this way, the N document identifiers are mapped by the hash function G ( ) into M indexes and stored in the index field G. In addition, the document identifiers “Doc_1”, “Doc_4”, and “Doc_6” are hashed by the hash function H ( ) to a same index IndexH_1, the document identifiers “Doc_2”, “Doc_5”, and “Doc_7” are hashed by the hash function H ( ) to another index IndexH_2, and so on. In this way, the N document identifiers are mapped by the hash function H ( ) into K indexes and stored in the index field K.

In some embodiments, to select the mapping functions, a value range of each selected mapping function (for example, a hash function) may be determined based on an upper limit of an enumerated value of an index field of data entities in the target data source. For example, if the upper limit of the enumerated value of the index field is 10 thousands, the value ranges of the hash function G ( ) and H ( ) are required to not exceeding 10 thousands when the mapping of the target data source is performed. In this way, all indexes corresponding to each hash function can be stored with a single index field without index slicing.

After the index information in the granularity of data entities is constructed and stored, the data query in the granularity of data entities of the target data source may be supported. The terminal device 110 receives a data query request for a target data source, where the data query request indicates a first entity identifier to be queried. For example, a user may initiate a data query request by interaction with the digital assistant 120. By analyzing the user input, one or more data entities that need to query the granularity of the data entity may be determined, and each data entity is identifier by a corresponding entity identifier.

The terminal device 110 may map the first entity identifier to be queried into a plurality of first indexes using a plurality of mapping functions. The plurality of mapping functions used herein are the same as the mapping functions used in building the index information, e.g., two hash functions G ( ) and H ( ) In some embodiments, if the data query request further indicates a second entity identifier of a second data entity to be queried, the terminal device 110 may also map the second entity identifier of the second data entity into the plurality of second indexes respectively by using the plurality of mapping functions. For example, if the user specifies the document identifier Doc_ID: {Doc_1. Doc_2 . . . . Doc_2000} of 2000 documents, the indexes g corresponding to the hash function G ( ) may be obtained as g={G (Doc_1), G (Doc_2), . . . , G (Doc_2000)}, and the indexes h of the hash function H ( ) may be obtained as h={H (Doc_1), H (Doc_2), . . . , H (Doc_2000)}.

Then, the terminal device 110 filters, based on the plurality of first indexes and the index information of the data entities in the target data source, the plurality of sets of first data entities that respectively match the plurality of first indexes from the target data source. For example, in FIG. 4, with an index G (Doc_1)=IndexG_1 corresponding to Doc_1, three documents, namely Doc_1, Doc_3, and Doc_5, may be filtered; with an index H (Doc_1)=IndexH_1 corresponding to Doc_1, three documents may be filtered, namely Doc_1. Doc_4, and Doc_6. Further, the terminal device 110 determines a query result for the data query request from an intersection set of the plurality of sets of first data entities, where the query result indicates at least a part of data entities included in the intersection set. For example, the document Doc_1 may be obtained after the first set of documents Doc_1, Doc_3, and Doc_5 and the second set of documents Doc_1, Doc_4 and Doc_6 are intersected.

If there is a further entity identifier, the terminal device 110 may filter, from the target data source, a plurality of sets of second data entities respectively matching with the plurality of second indexes, where the index information of each set of second data entities matches one of the plurality of second indexes. Then, the terminal device 110 determines a query result for the data query request from an intersection set of the plurality of sets of first data entities and the intersection set of the plurality of sets of second data entities, where the query result indicates at least a part of data entities included in the intersection set.

For the document identifier Doc_2, with the index G (Doc_2)=IndexG_2 corresponding to Doc_2, three documents, namely Doc_2. Doc_4, and Doc_6, may be filtered; with the index H (Doc_2)=IndexH_2 corresponding to Doc_2, three documents may be filtered, namely Doc_2, Doc_5 and Doc_7. After the intersection set is obtained, the document Doc_2 may be obtained. As such, documents Doc_1 and Doc_2 are determined as the query result.

Note that FIG. 4 indicates a simple example. In some practical applications, some redundant data entities may be obtained after the intersection, and these data entities do not match with entity identifiers to be queried. In this case, after the index fields of the data entities are filtered, a subsequent filtering process may be configured to remove irrelevant data entities.

In some embodiments, further improvements are proposed for the problem of storing too many index fields to support index of different granularities for too many storage hierarchical levels. Specifically, for each data entity in the target data source, except that an folder field needs to be created to store an index corresponding to the entity identifier of the data entity (for supporting the granularity of the data entity), a single folder field (represented as parent_folder) is also created and stored for each data entity, and is used to store a folder identifier (or an index after the folder identifier is mapped) that directly includes the parent folder of the current data entity.

That is, for each data entity, only two types of index fields need to be constructed, one type of index field is used to store an index in the granularity of data entity, and another type of index field is used to store an index corresponding to a direct parent folder. The latter type of index field may be used to support data filtering for different granularities. If the parent folder of a certain data entity is also included in the parent folder of the higher hierarchical level, then the folder identifier of the parent folder of the higher hierarchical level is not stored in the folder field. The storage hierarchy 300 of FIG. 3 is still taken as an example. For each document, in addition to the index field corresponding to the document identifier, for the document Doc_5, only the folder identifier “Folder_D” needs to be stored in the folder field parent_folder; for the document Doc_2, only the folder identifier “Folder_B” needs to be stored in the folder field parent_folder; for the document Doc_3, only the folder identifier “Folder_C” needs to be stored in the folder field parent_folder, and so on. For document Doc_1, only the folder identifier “Folder_A” needs to be stored in the folder field parent_folder.

After the index information is constructed and stored, the data query for each granularity of the target data source may be supported. Specifically, if the data query request received by the terminal device 110 indicates a first folder identifier to be queried, the terminal device 110 may determine whether a first folder identified by the first folder identifier further includes a subfolder. The terminal device 110 may obtain at least one second folder identifier of at least one subfolder in the first folder based on the first folder identifier. The terminal device 110 may obtain, through an interface, IDs of all folders including the first folder, denoted as f_IDs.

Then, the terminal device 110 filters a plurality of data entities matching the first folder identifier and the at least one second folder identifier from the target data source based on index information of data entities in the target data source. For example, the terminal device 110 may obtain, from the target data source, a data entity included in the folder identified by the first folder identifier and the at least one second folder identifier. In some examples, the terminal device 110 may set the filter condition parameter_follower=f_ID, and then obtain all documents under the folder identifier by f_IDs. The folder fields corresponding to these documents may indicate a certain folder identifier in f_IDs.

In the example of FIG. 4, it is assumed that the folder identifier included in the data query request is Folder_B, all subfolders under the folder Folder_B, namely Folder_D and Folder_F, may be obtained based on the storage hierarchy information. Since the folder field parent_folder of each document records the parent folder in which the document is located, the matched documents may be obtained by matching with the folder identifier with the folder field. For example, since the folder field parent_folder of the document Doc_2 matches the folder identifier Folder_B, the document Doc_2 under the folder may be obtained; since the folder field parent_folder of the document Doc_5 matches the folder identifier Folder_D, the document Doc_5 under the folder may be obtained if the document Doc_5 is also a document under the folder Folder_F.

Although all subfolder lists need to be obtained at a certain cost of time during filtering, the foregoing solution only needs to store a single field parent_folder in the index information to support finer granularity of data filtering, which greatly reduces the storage space. In addition, if the number of subfolder in each folder is less relative to the number of documents (the large probability is less than 5000), the above solution can cope with the problem of exceeding the upper limit (e.g., 5000) for the enumerated value of a single filter under the folder.

Embodiments described above that utilize a plurality of many-to-one mapping functions to build index information and/or to retrieve all data entities under a folder identifier refilter-folder may be used alone or in combination with one another. In addition, embodiments of constructing the index information using a plurality of many-to-one mapping functions described above and/or embodiments of retrieving all data entities in the folder identifier refilter-folder first may be combined in the question answering data query embodiment based on the digital assistant in FIGS. 2A-2C, or may be applied in a use scenario of data query independent of the digital assistant.

It should be understood that some embodiments of the present disclosure are described above with reference to specific examples in the accompanying drawings, but these specific examples are not intended to limit the scope of the embodiments of the present disclosure. The described embodiments may also be implemented in various other deformation.

FIG. 5A shows a flowchart of a process 500 for plugin creation according to some embodiments of the present disclosure. The process 500 may be implemented at the terminal device 110. For ease of discussion, the process 500 will be described with reference to the environment 100 of FIG. 1.

At block 510, the terminal device 110 provides a creation page for creating a target plugin, where the creation page presents a plugin creation template corresponding to a type of the target plugin to be created, and the plugin creation template includes at least one information input component.

At block 520, the terminal device 110 obtains plugin creation information about the target plugin at least via at least one information input component in the plugin creation template.

At block 530, the terminal device 110 releases the target plugin based on the plugin creation information, the released target plugin being selectable for interaction between a user and a digital assistant.

In some embodiments, providing a creation page for creating a target plugin comprises: receiving a plugin creation request indicating a type of a plugin to be created; and providing a creation page for creating the target plugin based on the plugin creation request.

In some embodiments, the plugin creation template is determined based on template information corresponding to the type of the target plugin, the template information indicating at least one information input component required to create a plugin associated with the type.

In some embodiments, a type corresponding to the target plugin is a question answering plugin, and the plugin creation template at least includes: a first information input component configured to specify one or more datasets corresponding to the question answering plugin.

In some embodiments, the first information input component includes at least: a first portion configured to input a type of the one or more datasets; and a second portion configured to input a source of the one or more datasets.

In some embodiments, the plugin creation template further includes at least one of the following: a second information input component configured to input identification information of the target plugin, where the identification information includes a text identifier and/or an image identifier; or a third information input component configured to input description text of the target plugin.

In some embodiments, the plugin creation information further includes permission information, and the permission information at least indicates a range of users accessible to the target plugin. In some embodiments, the plugin creation information further includes: plugin processing capability information pre-configured for the plugin creation template, where the plugin processing capability information corresponds to the type of the target plugin.

In some embodiments, releasing the target plugin based on the plugin creation information includes: releasing the target plugin in response to an approval of the plugin creation information.

FIG. 5B illustrates a flowchart of a process 501 for data query according to some embodiments of the present disclosure. The process 501 may be implemented at the terminal device 110. For ease of discussion, the process 501 will be described with reference to the environment 100 of FIG. 1.

At block 511, the terminal device 110 receives a data query request for a target data source, where the data query request indicates a first entity identifier to be queried.

At block 521, the terminal device 110 maps the first entity identifier into a plurality of first indexes by using a plurality of mapping functions, and each mapping function maps a plurality of different entity identifiers to a same index.

At block 531, the terminal device 110 filters, based on the plurality of first indexes and the index information of the data entity in the target data source, a plurality of sets of first data entities respectively matching with the plurality of first indexes from the target data source, where the index information of each set of data entities matches one of the plurality of first index.

At block 540, the terminal device 110 determines a query result for the data query request from an intersection set of the plurality of sets of first data entities, where the query result indicates at least a part of data entities included in the intersection set.

In some embodiments, the process 501 further includes: for a data entity in the target data source, mapping an entity identifier of the data entity into a plurality of indexes by using a plurality of mapping functions; and storing the plurality of indexes respectively in a plurality of index fields of the data entity as index information of the data entity.

In some embodiments, the plurality of mapping functions includes two different mapping functions.

In some embodiments, the plurality of mapping functions includes a plurality of hash functions, and a value range of each hash function is determined based on an upper limit of an enumerated value of an index field of data entities in the target data source.

In some embodiments, the data query request further indicates a second entity identifier of the second data entity to be queried, and determining the query result for the data query request further includes: mapping the second entity identifier of the second data entity into a plurality of second indexes respectively by using a plurality of mapping functions; filtering, from the target data source, a plurality of sets of second data entities respectively matching with the plurality of second indexes, where the index information of each set of second data entities matches one of the plurality of second index; and determining a query result for the data query request from an intersection set of the plurality of sets of first data entities and the intersection set of the plurality of sets of second data entities, where the query result indicates at least a part of data entities included in the intersection set.

In some embodiments, a data entity in the target data source includes a document.

FIG. 5C illustrates a flowchart of a process 502 for data query according to some embodiments of the present disclosure. Process 502 may be implemented at the terminal device 110. For ease of discussion, the process 502 will be described with reference to the environment 100 of FIG. 1.

At block 512, the terminal device 110 receives a data query request for a target data source, where the data query request indicates a first folder identifier to be queried.

At block 522, the terminal device 110 obtains, in response to determining that a first folder identified by the first folder identifier has a subfolder, at least one second folder identifier of the at least one subfolder in the first folder based on the first folder identifier.

At block 532, the terminal device 110 filters, from the target data source, a plurality of data entities matching with the first folder identifier and the at least one second folder identifier based on index information of data entities in the target data source, index information of each data entity at least comprising a folder field indicating the first folder identifier and a folder identifier of the at least one second folder identifier.

In some embodiments, the process 502 further includes: for a first data entity in the target data source, creating index information of the first data entity, the index information including at least a folder field; and storing a folder identifier directly including the first data entity of the parent folder into a folder field of the index information.

In some embodiments, the parent folder of the first data entity is further included in a further parent folder, and a folder identifier of the further parent folder is not stored in the folder field.

In some embodiments, the process 502 further includes: storing an index corresponding to the entity identifier of the first data entity in the folder field of the index information.

In some embodiments, filtering the plurality of data entities from the target data source includes obtaining, from the target data source, data entities included within folders identified by the first folder identifier and by at least one second folder identifier.

FIG. 5D illustrates a flowchart of a process 504 for data query according to some embodiments of the present disclosure. Process 504 may be implemented at the terminal device 110. For ease of discussion, the process 504 will be described with reference to the environment 100 of FIG. 1.

At block 514, the terminal device 110 determines a target data source of a question answering plugin used by the digital assistant based on the first configuration operation of the user.

At block 524, the terminal device 110 receives a data query request of the user in an interaction between the user and the digital assistant.

At block 534, the terminal device 110 presents a query result of the digital assistant to the user, where the query result is obtained by the digital assistant which matches the data query request with the target data source using the question answering plugin.

In some embodiments, the target data source includes one or more online documents.

In some embodiments, the data query request indicating a data identifier to be queried, and the query result is obtained by: determining, from the target data source, a set of data entities that the user has permission; filtering, from the set of data entities, at least one data entity that matches the data identifier based on index information of the target data source; and presenting the at least one determined data entity to the user.

In some embodiments, the data identifier includes an entity identifier or a folder identifier to be queried.

In some embodiments, filtering the at least one data entity that matches the data identifier from the set of data entities includes filtering, based on index information constructed for the set of data entities, at least one data entity that matches the data identifier from the set of data entities using the data identifier.

FIG. 6A is a schematic structural block diagram of an apparatus 600 for plugin creation according to some embodiments of the present disclosure. The apparatus 600 may be implemented or included in the terminal device 110. The various modules/components in the apparatus 600 may be implemented in hardware, software, firmware, or any combination thereof.

The apparatus 600 includes a page providing module 610 configured to provide a creation page for creating a target plugin, where the creation page presents a plugin creation template corresponding to a type of the target plugin to be created, and the plugin creation template includes at least one information input component. The apparatus 600 further includes an information obtaining module 620 configured to obtain plugin creation information about the target plugin at least via at least one information input component in the plugin creation template. The apparatus 600 further includes a plugin releasing module 630 configured to release the target plugin based on the plugin creation information, the released target plugin being selectable for interaction between a user and a digital assistant.

In some embodiments, the page providing module 610 includes: a creation request receiving module configured to receive a plugin creation request indicating a type of a plugin to be created; and a creation page providing module configured to provide a creation page for creating the target plugin based on the plugin creation request.

In some embodiments, the plugin creation template is determined based on template information corresponding to the type, the template information indicating at least one information input component required to create a plugin associated with the type.

In some embodiments, the type corresponding to the target plugin is a question answering plugin, and the plugin creation template at least includes: a first information input component configured to specify one or more datasets corresponding to the question answering plugin.

In some embodiments, the first information input component includes at least: a first portion configured to input a type of the one or more datasets; and a second portion configured to input a source of the one or more datasets.

In some embodiments, the plugin creation template further includes at least one of the following: a second information input component configured to input identification information of the target plugin, where the identification information includes a text identifier and/or an image identifier; and a third information input component configured to input description text of the target plugin.

In some embodiments, the plugin creation information further includes permission information, and the permission information at least indicates a range of users accessible to the target plugin.

In some embodiments, the plugin releasing module 630 includes a releasing module configured to release the target plugin in response to an approval of the plugin creation information.

FIG. 6B shows a schematic structural block diagram of an apparatus 601 for data query according to some embodiments of the present disclosure. The apparatus 601 may be implemented or included in the terminal device 110. The various modules/components in the apparatus 601 may be implemented in hardware, software, firmware, or any combination thereof.

The apparatus 601 includes a request receiving module 611 configured to receive a data query request for a target data source, the data query request indicating a first entity identifier to be queried.

The apparatus 601 further includes an index mapping module 621 configured to map the first entity identifier into a plurality of first indexes respectively by using a plurality of mapping functions, where each mapping function maps a plurality of different entity identifiers to a same index.

The apparatus 601 further includes a data filtering module 631 configured to filter, based on the plurality of first indexes and index information of data entities in the target data source, a plurality of sets of first data entities that respectively match with plurality of first indexes from the target data source, where the index information of each set of data entities matches one of the plurality of first index.

The apparatus 601 further includes a result determination module 640 configured to determine a query result for the data query request from an intersection set of the plurality of sets of first data entities, where the query result indicates at least a part of data entities included in the intersection set.

In some embodiments, the apparatus 601 further includes: an index mapping module configured to, for a data entity in the target data source, map an entity identifier of the data entity into a plurality of indexes by using a plurality of mapping functions; and an index storing module configured to store the plurality of indexes in a plurality of index fields of the data entity, respectively, as index information of the data entity.

In some embodiments, the plurality of mapping functions includes two different mapping functions.

In some embodiments, the plurality of mapping functions includes a plurality of hash functions, and a value range of each hash function is determined based on an upper limit of an enumerated value of an index field of data entities in the target data source.

In some embodiments, the data query request further indicates a second entity identifier of the second data entity to be queried. The result determination module 640 is further configured to: map a second entity identifier of the second data entity into a plurality of second indexes respectively by using a plurality of mapping functions; filter, from the target data source, a plurality of sets of second data entities respectively matching with plurality of second indexes, where the index information of each set of second data entities matches one of the plurality of second index; and determine a query result for the data query request from an intersection set of the plurality of sets of first data entities and the intersection set of the plurality of sets of second data entities, where the query result indicates at least a part of data entities included in the intersection set.

In some embodiments, a data entity in the target data source includes a document.

FIG. 6C shows a schematic structural block diagram of an apparatus 602 for data query according to some embodiments of the present disclosure. The apparatus 602 may be implemented or included in the terminal device 110. The various modules/components in the apparatus 602 may be implemented in hardware, software, firmware, or any combination thereof.

The apparatus 602 includes a request receiving module 612 configured to receive a data query request for a target data source, where the data query request indicates a first folder identifier to be queried.

The apparatus 602 further includes an identifier obtaining module 622 configured to, in response to determining that a first folder identified by the first folder identifier has a subfolder, obtain at least one second folder identifier of at least one subfolder in the first folder based on the first folder identifier.

The apparatus 602 further includes a data filtering module 632 configured to filter, based on index information of data entities in the target data source, a plurality of data entities matching with the first folder identifier and the at least one second folder identifier from the target data source, where the index information of each data entity includes at least a folder field indicating the first folder identifier and a folder identifier of the at least one second folder identifier.

In some embodiments, the apparatus 602 further includes: an index creating module configured to, for a first data entity in the target data source, create index information of the first data entity, the index information including at least a folder field; and a folder index storing module configured to store a folder identifier directly including a parent folder of the first data entity into a folder field of the index information.

In some embodiments, the parent folder of the first data entity is further included in a further parent folder, and a folder identifier of the further parent folder is not stored in the folder field.

In some embodiments, the apparatus 602 further includes an entity index storing module configured to store an index corresponding to the entity identifier of the first data entity in the folder field of the index information.

In some embodiments, the data filtering module 632 further includes: obtaining, from the target data source, data entities included within folders identified by the first folder identifier and by the at least one second folder identifier.

FIG. 6D shows a schematic structural block diagram of an apparatus 604 for data query according to some embodiments of the present disclosure. The apparatus 604 may be implemented or included in the terminal device 110. The various modules/components in the apparatus 604 may be implemented in hardware, software, firmware, or any combination thereof.

The apparatus 604 includes a data source determination module 614 configured to determine, based on a first configuration operation of a user, a target data source of a question answering plugin used by the digital assistant.

The apparatus 604 further includes a request receiving module 624 configured to receive a data query request of the user in an interaction between the user and the digital assistant.

The apparatus 604 further includes a result presenting module 634 configured to present a query result of the digital assistant to the user, wherein the query result is obtained by the digital assistant which matches the data query request with the target data source using the question answering plugin.

In some embodiments, the target data source includes one or more online documents.

In some embodiments, the data query request indicates a data identifier to be queried, and the query result is obtained by: determining, from the target data source, a set of data entities that the user has permission; filtering, from the set of data entities, at least one data entity that matches the data identifier based on index information of the target data source; and presenting the at least one determined data entity to the user.

In some embodiments, the data identifier includes an entity identifier or a folder identifier to be queried.

In some embodiments, the data filtering module 634 is further configured to filter, based on index information constructed for the set of data entities, at least one data entity that matches the data identifier from the set of data entities using the data identifier.

The units and/or modules included in the apparatus 600, the apparatus 601, the apparatus 602, and/or the apparatus 604 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600, the apparatus 601, the apparatus 602, and/or the apparatus 604 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or a combination of electronic devices may include, for example, the server 130, the terminal device 110, and/or a combination of the server 130 and the terminal device 110 in FIG. 1.

FIG. 7 illustrates a block diagram of an electronic device 700 in which one or more embodiments of the present disclosure may be implemented. It should be understood that the electronic device 700 illustrated in FIG. 7 is merely an example and should not be considered as any limitation on the functionality and scope of the embodiments described herein. The electronic device 700 shown in FIG. 7 may be configured to implement the server 130, the terminal device 110, and/or a combination of the server 130 and the terminal device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to program stored in the memory 720. In multiprocessor system, a plurality of processing units execute computer-executable instructions in parallel to improve parallel processing capabilities of electronic device 700.

Electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 720 may include a computer program product 725 having one or more program module modules configured to perform various methods or actions of various embodiments of the present disclosure.

The communication unit 740 is configured to communicate with further electronic devices through a communication medium. Additionally, the functionality of components of the electronic device 700 may be implemented in a single computing cluster or a plurality of computing machines capable of communicating over a communication connection. Thus, the electronic device 700 may operate in a networked environment using logical connections with one or more other servers, network personal computers (PCs), or other network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instruction.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instruction may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instruction may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for plugin creation, comprising:
providing a creation page for creating a target plugin, wherein the creation page presents a plugin creation template corresponding to a type of the target plugin to be created, and the plugin creation template comprises at least one information input component;
obtaining plugin creation information about the target plugin at least via the at least one information input component in the plugin creation template; and
releasing the target plugin based on the plugin creation information, the released target plugin being selectable for interaction between a user and a digital assistant.

2. The method of claim 1, wherein providing a creation page for creating a target plugin comprises:
receiving a plugin creation request indicating a type of a plugin to be created; and
providing the creation page for creating the target plugin based on the plugin creation request.

3. The method of claim 1, wherein the plugin creation template is determined based on template information corresponding to the type of the target plugin, the template information indicating at least one information input component required to create a plugin associated with the type.

4. The method of claim 1, wherein a type corresponding to the target plugin is a question answering plugin, and the plugin creation template at least comprises:
a first information input component configured to specify one or more datasets corresponding to the question answering plugin.

5. The method of claim 4, wherein the first information input component comprises at least:
a first portion configured to input a type of the one or more datasets; and
a second portion configured to input a source of the one or more datasets.

6. The method of claim 1, wherein the plugin creation template further comprises at least one of the following:
a second information input component configured to input identification information of the target plugin, wherein the identification information comprises a text identifier and/or an image identifier; or
a third information input component configured to input description text of the target plugin.

7. The method of claim 1, wherein the plugin creation information further comprises permission information, the permission information at least indicating a range of users accessible to the target plugin.

8. The method of claim 1, wherein the plugin creation information further comprises: plugin processing capability information pre-configured for the plugin creation template, wherein the plugin processing capability information corresponds to the type of the target plugin.

9. The method of claim 1, wherein releasing the target plugin based on the plugin creation information comprises:
releasing the target plugin in response to an approval of the plugin creation information.

10. A method for data query, comprising:
determining a target data source of a question answering plugin used by a digital assistant based on a first configuration operation of a user;
receiving a data query request of the user in an interaction between the user and the digital assistant; and
presenting a query result of the digital assistant to the user, wherein the query result is obtained by the digital assistant which matches the data query request with the target data source using the question answering plugin.

11. The method of claim 10, wherein the target data source comprises one or more online documents.

12. The method of claim 10, wherein the data query request indicates a data identifier to be queried, and the query result is obtained by:
determining, from the target data source, a set of data entities to which the user has permission;
filtering at least one data entity matching with the data identifier from the set of data entities based on index information of the target data source; and
presenting the at least one determined data entity to the user.

13. The method of claim 12, wherein the data identifier comprises: an entity identifier or a folder identifier to be queried.

14. The method of claim 12, wherein filtering at least one data entity from the set of data entities that matches the data identifier comprises:
filtering, based on index information constructed for the set of data entities, from the set of data entities, at least one data entity that matches the data identifier, using the data identifier.

15. An electronic device comprises:
at least one processing unit; and
at least one memory coupled to the at least one processing unit and storing instructions for execution by the at least one processing unit, the instructions, when executed by the at least one processing unit, causing the electronic device to perform acts comprising:
providing a creation page for creating a target plugin, wherein the creation page presents a plugin creation template corresponding to a type of the target plugin to be created, and the plugin creation template comprises at least one information input component;
obtaining plugin creation information about the target plugin at least via the at least one information input component in the plugin creation template; and
releasing the target plugin based on the plugin creation information, the released target plugin selectable for interaction between a user and a digital assistant.

16. The electronic device of claim 15, wherein providing a creation page for creating a target plugin comprises:
receiving a plugin creation request indicating a type of a plugin to be created; and
providing the creation page for creating the target plugin based on the plugin creation request.

17. The electronic device of claim 15, wherein the plugin creation template is determined based on template information corresponding to the type, the template information indicating at least one information input component required to create a plugin associated with the type.

18. An electronic device comprises:
at least one processing unit; and
at least one memory coupled to the at least one processing unit and storing instructions for execution by the at least one processing unit, the instructions, when executed by the at least one processing unit, causing the electronic device to perform acts comprising:
determining a target data source of a question answering plugin used by a digital assistant based on a first configuration operation of a user;
receiving a data query request of the user in an interaction between the user and the digital assistant; and
presenting a query result of the digital assistant to the user, wherein the query result is obtained by the digital assistant which matches the data query request with the target data source using the question answering plugin.

19. The electronic device of claim 18, wherein the target data source comprises one or more online documents.

20. The electronic device of claim 18, wherein the data query request indicates a data identifier to be queried, and the query result is obtained by:
determining, from the target data source, a set of data entities to which the user has permission;
filtering at least one data entity matching with the data identifier from the set of data entities based on index information of the target data source; and
presenting the at least one determined data entity to the user.
